(19) United States
(12) Patent Application Publication
(10) Pub. No.: US 2013/0039842 A1
(43) Pub. Date: Feb. 14, 2013

(54) METHOD FOR PRODUCING CHLORINE USING FIXED BED REACTOR

(71) Applicants: Junichi Nishida, Niihama-shi (JP); Yasuhiko Mori, Niihama-shi (JP)

(72) Inventors: Junichi Nishida, Niihama-shi (JP); Yasuhiko Mori, Niihama-shi (JP)

(21) Appl. No.: 13/583,551

(22) PCT Filed: Mar. 4, 2011
(86) PCT No.: PCT/JP2011/001294

§ 371 Date: Sep. 7, 2012

(30) Foreign Application Priority Data
Mar. 11, 2010 (JP) 2010-054604

(51) Int. Cl. C01B 7/04; B01J 8/06

(52) U.S. Cl. 423/502; 422/129

(57) ABSTRACT

The present invention is a method of producing chlorine where it is possible to inhibit the degradation of a catalyst, the corrosion of an apparatus material caused by raw material hydrogen chloride and/or generated chlorine, and a runaway reaction by preventing hot spot generation in a catalyst layer, wherein the method includes a reaction of oxidizing hydrogen chloride in a gas containing the hydrogen chloride using a gas containing oxygen by a fixed bed reactor having a reaction region composed of a catalyst layer and the catalyst layer has an effective thermal conductivity of 0.30 W/(Km) or more, based on a catalyst-filled layer, measured at 350° C. in an air atmosphere.

### TECHNICAL FIELD

The present invention relates to a method for producing chlorine using a fixed bed reactor.

### BACKGROUND ART

Chlorine can be obtained through oxidation of hydrogen chloride by a gas phase catalytic reaction. In a multitubular fixed bed reactor to be used for the oxidation by a gas phase catalytic reaction, the removal of generated heat of reaction has been carried out by circulating a heat medium, such as a molten salt, within a reactor shell.

However, an oxidation reaction of hydrogen chloride is an exothermic reaction of 59 kJ/mol-Cl₂, and a hot spot that occurs in a catalyst layer (i.e., local abnormal rise in temperature) causes degradation of a catalyst, corrosion of an apparatus material by raw material hydrogen chloride and/or generated chlorine, a runaway reaction, and so on, thereby causing problems in production. Therefore, in an oxidation reaction of hydrogen chloride by a fixed bed reactor, it is required to properly carry out the removal of heat of reaction generated through the oxidation reaction.

Tadamitsu Kiyoura et al. (other two coauthors), “Recovery of chlorine from hydrogen chloride”, Catalyst, JAPAN, Catalysis Society of Japan, 1991, Vol. 33, p. 15 (non-patent literature 1) describes that in a reaction between pure hydrogen chloride and pure oxygen using chromium oxide as a catalyst it is difficult to prevent hot spot generation in a fixed bed reaction and it is necessary to adopt a fluidized bed system for real apparatuses.

On the other hand, as one means for preventing hot spot generation in a method for producing chlorine using a fixed bed reactor, Japanese Patent Laying-Open No. 2000-281314 (patent literature 1) discloses to improve the thermal conductivity of a catalyst itself by improving the thermal conductivity of a catalyst support where a catalytically active component is to be supported (by improving the thermal conductivity by using a catalyst that contains a highly thermally-conductive substance as a component), thereby promoting the removal of heat of reaction.

The method disclosed in Japanese Patent Laying-Open No. 2001-199710 (patent literature 2) tries to inhibit a hot spot by maintaining the heat-removing capacity of a reactor by promoting heat transfer in a catalyst layer by specifying the linear velocity of a gas on a superficial basis in a reaction tube. The linear velocity of a gas on a superficial basis means the ratio of the sum total of the feeding rates of all gases to be fed to a catalyst-filled layer in the standard conditions (0° C., 0.1 MPa) to the sectional area of a reaction tube.

### CITATION LIST

### Patent Literature

PTL 1: Japanese Patent Laying-Open No. 2000-281314
PTL 2: Japanese Patent Laying-Open No. 2001-199710
PTL 3: Japanese Patent Laying-Open No. 2000-272907

### Non Patent Literature

NPL 1: Tadamitsu Kiyoura et al. (other two coauthors), “Recovery of chlorine from hydrogen chloride”, Catalyst, JAPAN, Catalysis Society of Japan, 1991, Vol. 33, p. 15
NPL 2: “Industrial Reaction Apparatus”, written and edited by Kenji Hashimoto, Baifukan Co., Ltd., January 1984, p. 22

### SUMMARY OF INVENTION

### Technical Problem

Even if a catalyst containing a highly thermally-conductive substance as a component is used as described in patent literature 1, the thermal conductivity of a catalyst layer does not necessarily become high because of the influence of, for example, the catalyst filling ratio derived from the proportion of pores or voids existing in a catalyst (i.e., pore volume), the shape of a catalyst (spherical shape, cylindrical shape, ring shape, and so on), the size of a catalyst, and the variation of the way of filling a catalyst into a reaction tube even if the thermal conductivity of a catalyst or a catalyst support is improved. In other words, just the improvement in thermal conductivity of a catalyst itself to be filled is not sufficient to prevent hot spot generation in a fixed bed reactor.

In the method disclosed in the aforementioned patent literature 2, the catalyst activity is high at the start-up of a reaction, and the specified linear velocity of a gas cannot be satisfied in operation at a low load and, as a result, the heat-removing capacity becomes insufficient, so that a hot spot is formed.

On the other hand, as a means for preventing hot spot generation, there have been used means such as increasing the surface area per unit volume of a reaction tube by reducing the diameter of the reaction tube (for example, “Industrial Reaction Apparatus”, written and edited by Kenji Hashimoto, Baifukan Co., Ltd., January 1984, p. 22 (non-patent literature 2)), reducing heat of reaction generated per unit volume of a reaction tube by reducing the reaction rate by filling an inactive substance together with a catalyst (for example, Japanese Patent Laying-Open No. 2000-272907 (patent literature 3), and reducing heat of reaction by reducing the reaction rate by diluting a raw material gas (for example, non-patent literature 1). In order to obtain a prescribed amount of chlorine in such a case, redundant costs are needed for the increase in the number of necessary reaction tubes, the purification of diluted generated chlorine, and so on, which is industrially disadvantageous.

Under such situations, a problem that the present invention intends to solve is to provide a method for producing chlorine by oxidizing hydrogen chloride by a gas phase catalytic reaction, whereby preventing hot spot generation in a catalyst layer to prevent degradation of a catalyst, corrosion of an apparatus material caused by raw material hydrogen chloride and/or generated chlorine, and a runaway reaction.

### Solution to Problem

The present inventors paid their attention to a process of removing heat of a catalyst layer in a fixed bed reactor and investigated means for preventing hot spot generation in the catalyst layer. That is, it was found that among four factors of a process where heat of reaction generated by a reaction in a fixed bed reactor is removed, i.e., heat transfer in a catalyst layer, heat transfer through a fluid film near a reactor wall from the side of the catalyst layer, heat transfer in a reactor wall surface, and heat transfer toward a heat medium through the fluid film near the reactor wall, the factor that is relatively low in coefficient of heat transfer and dominates the heat transfer in the reactor was the heat transfer in the catalyst layer, and this factor had more room to be improved than other three factors.

Consequently, the present inventors have reached the present invention by finding that improvement in effective thermal conductivity based on a catalyst-filled layer improves the capability of removing a large amount of heat of reaction generated in a reactor while maintaining reactivity necessary for production, eventually results in reduction of hot spot generation, and can prevent degradation of a catalyst, corrosion of an apparatus material caused by raw material hydrogen chloride and/or generated chlorine, and a runaway reaction.

That is, the present invention relates to a method for producing chlorine, wherein the method includes a reaction of oxidizing hydrogen chloride in a gas containing the hydrogen chloride using a gas containing oxygen by a fixed bed reactor having a reaction region composed of a catalyst layer and the catalyst layer has an effective thermal conductivity of 0.30 W/(Km) or more, based on a catalyst-filled layer, measured at 350° C. in an air atmosphere.

For the production of chlorine using the catalyst layer, it is preferred that a catalyst be filled into a reaction tube that is made of a metal and has an inner diameter of from 20 mm to 40 mm.

It is preferred that the sum total of gas components that do not participate in the reaction to the hydrogen chloride contained in the gas at a gas inlet of the reaction tube filled with the catalyst, i.e., components other than HCl, O₂, Cl₂, and H₂O, be 30% by volume or less.

It is preferred that the reaction tube filled with the catalyst have on its outer circumferential surface a jacket filled with a heat medium for removing heat of reaction and the temperature of the salt bath be from 250° C. to 400° C.

It is preferred that the catalyst be a pellet-shaped body having a pore volume of from 0.15 cm³/g to 0.30 cm³/g, and the voidage e of the reaction tube filled with the catalyst be from 0.6 to 0.8.

The present invention also relates to a reaction tube to be used in a method for producing chlorine including a reaction of oxidizing hydrogen chloride in a gas containing the hydrogen chloride using a gas containing oxygen by using a fixed bed reactor. The reaction tube is characterized in that a catalyst layer is constituted by filling a catalyst, the catalyst is a pellet-shaped body having a pore volume of from 0.15 cm³/g to 0.30 cm³/g, the voidage of the reaction tube filled with the catalyst is from 0.6 to 0.8, and the catalyst layer has an effective thermal conductivity of 0.30 W/(Km) or more, based on a catalyst-filled layer, measured at 350° C. in an air atmosphere.

### Advantageous Effects of Invention

In the method for producing chlorine of the present invention, the use of a layer having an effective thermal conductivity of 0.30 W/(Km) or more, based on a catalyst-filled layer, measured at 350° C. in an air atmosphere, as a catalyst layer, can inhibit a hot spot better than conventional methods. Because it is possible to inhibit a hot spot better in such a manner than conventional methods, the following effects are obtained.

(1) Although a catalyst is thermally degraded rapidly because of a hot spot, so that the frequency of catalyst exchange is so high that a large cost has been required in a conventional method, costs of a catalyst and its filling can be saved by the method of the present invention because the thermal degradation of the catalyst can be prevented.

(2) Since the reactivity of raw material hydrogen chloride and/or generated chlorine with an apparatus material can be reduced by preventing hot spot generation further than a conventional method, the corrosion of the apparatus material can be reduced, so that an equipment cost can be reduced.

(3) Since the heat-removing capability is higher than a conventional method even in a low-load operation, runaway of a reaction can be suppressed and a method for stable chlorine production can be provided.

(4) In a conventional method, in order to make the heat transfer area for increasing the amount of heat exchange per unit volume of a reactor larger in a case of obtaining a certain amount of chlorine, the diameter of a reaction tube has been reduced and the number of reaction tubes has been increased instead. In the method of the present invention, an equipment cost can be saved because increase in effective thermal conductivity based on a catalyst-filled layer makes it unnecessary to reduce the diameter of a reaction tube and the number of reaction tubes necessary for obtaining a prescribed amount of chlorine can be reduced than before.

(5) It is not necessary to reduce a reaction rate by diluting a raw material hydrogen chloride gas for preventing hot spot generation as in a conventional method. Therefore, since the concentration of a chlorine gas contained in a generated gas becomes high, a purification cost of generated chlorine can be saved and chlorine of a high purity can be obtained in a high yield.

(6) It is not necessary to reduce a reaction rate by reducing the proportion of a catalytically active component by filling a catalytically inactive component into a catalyst layer as in a conventional method in order to prevent hot spot generation. Therefore, since a reaction can be performed using a highly active catalyst as a catalyst, the reaction rate can be maintained high and a cost can be reduced by miniaturizing a reactor.

### BRIEF DESCRIPTION OF DRAWINGS

FIG. 1A is a schematic sectional view of one example of a fixed bed reactor in the present invention.

FIG. 1B is a schematic diagram for illustrating a catalyst layer of the present invention.

FIG. 2 is a schematic sectional view of one example of a fixed bed reaction apparatus containing a reaction tube of the present invention.

FIG. 3 is a graph showing the relation between the length and the central temperature of a reaction tube in Example 1.

FIG. 4 is a graph showing the relation between the length and the central temperature of a reaction tube in Example 2.

FIG. 5 is a graph showing the relation between the length and the central temperature of a reaction tube in Example 3.

FIG. 6 is a graph showing the relation between the length and the central temperature of a reaction tube in Example 4.

FIG. 7 is a graph showing the relation between the length and the central temperature of a reaction tube in Comparative Example 1.

FIG. 8 is a graph showing the relation between the length and the central temperature of a reaction tube in Comparative Example 2.

FIG. 9 is a graph showing the relation between the length and the central temperature of a reaction tube in Example 5.

### DESCRIPTION OF EMBODIMENTS

In the following, the present invention will be described in more detail. In the following description of exemplary embodiments, the description is made with reference to drawings, and items with the same referential symbol indicate the same parts or corresponding parts in the drawings of the present application.

The present invention relates to a method for producing chlorine characterized by using a catalyst layer having an effective thermal conductivity of 0.30 W/(Km) or more, based on a catalyst-filled layer, measured at 350° C. in an air atmosphere by the method provided in JIS R2616 (2001), as a catalyst layer of a reactor (fixed bed type reactor) for gas phase catalytic oxidation of hydrogen chloride. The “effective thermal conductivity” (synonymous with effective thermally conducting ratio) refers to an average thermal conductivity of a catalyst filled and air filling a gap thereof, and the “effective thermal conductivity based on a catalyst-filled layer” in the present invention refers to an effective thermal conductivity that a catalyst layer exhibits by the aforementioned measuring method when a catalyst is filled in an arbitrary container.

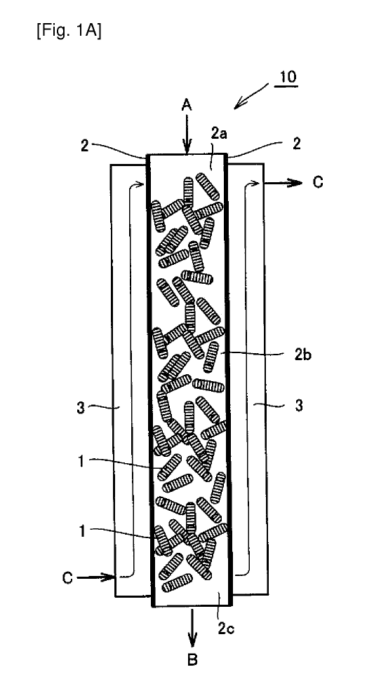

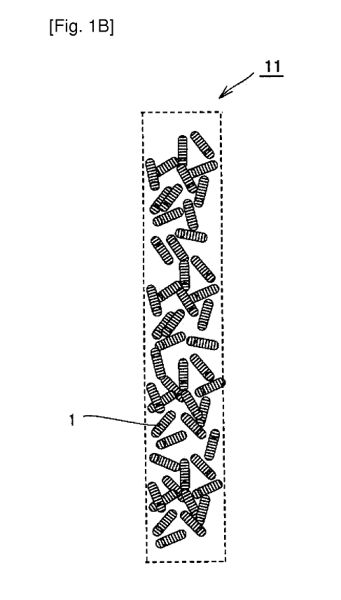

A schematic sectional view of one example of a fixed bed reactor to be used in the present invention is shown in FIG. 1A. As depicted in FIG. 1A, a fixed bed reactor 10 has a reaction tube 2 filled with a catalyst 1 and it may optionally have a jacket 3 where a heat medium such as a base bath can be made to pass. Jacket 3 is mounted to the outer circumferential surface of reaction tube 2. A gas A, such as a gas containing hydrogen chloride, is introduced from the side of a gas inlet 2a of reaction tube 2, a reaction occurs in a catalyst-filled layer 2b (corresponding to a catalyst layer 11 of FIG. 1B) filled with a catalyst, and a gas B after the reaction is discharged from the side of a gas outlet 2c.

As depicted in FIG. 1B, catalyst 1 is in a fixed form in a state where it has been filled in a reaction tube, forming catalyst layer 11. FIG. 1B is a drawing produced by removing jacket 3 and reaction tube 2 from FIG. 1A, and a region surrounded by a dashed line of FIG. 1B shows a region having the same volume as that of a space surrounded by an inner wall of reaction tube 2 shown in FIG. 1A.

In the present invention, the effective thermal conductivity based on a catalyst-filled layer is a value measured by an unsteady hot-wire method in accordance with JIS R2616 (2001) and can be measured, for example, by using a thermal conductivity measurement apparatus ARC-TC-100 manufactured by AGNE Gijutsu Center. In order to prevent hot spot generation, it is just required that the effective thermal conductivity based on a catalyst-filled layer from the gas inlet of a reaction tube to a position where the reaction rate is high in the reaction tube, corresponding to a hot spot, be 0.30 W/(Km) or more, but it is desirable that the effective thermal conductivity from the gas inlet side to the gas outlet side of the reaction tube be adjusted to 0.30 W/(Km) or more because the position where a hot spot appears varies depending upon the gas linear velocity on a superficial basis and the degradation state of a catalyst.

The reaction tube where the catalyst is filled may be one having one reaction region in the longitudinal direction as illustrated in FIG. 1A, or it is also permissible that the reaction tube is divided in the longitudinal direction into at least two reaction regions to form multiple reaction regions and catalysts differing in catalytic activity are filled into the respective reaction regions, and a reaction is suppressed in the tube, so that the temperature regulation of the whole reaction tube is achieved. In the present invention, when there are multiple reaction regions like this, it is preferred that the effective thermal conductivity of each of the multiple reaction regions is 0.30 W/(Km) or more.

Although the above-described effect of the present invention is exhibited when the effective thermal conductivity based on a catalyst-filled layer is 0.30 W/(Km) or more, the rise of an in-tube temperature caused by heat of reaction is suppressed more if the effective thermal conductivity becomes higher, so that the temperature controllability is enhanced.

The catalyst layer is a layer filled with a material that serves as a catalyst of an oxidation reaction in a reaction of oxidizing hydrogen chloride in a gas containing the hydrogen chloride with oxygen in a gas containing the oxygen, and for inhibition of degradation of a catalyst because of the fact that a reaction can be done at low temperatures and for an efficient reaction it is preferred for an oxidation reaction catalyst to be filled into reactor 2 (catalyst 1) that its catalytically active component contain Ru or RuO₂. Moreover, it is preferred that a catalyst support contain Al₂O₃ and TiO₂ because of ease of adjusting the effective thermal conductivity based on a catalyst-filled layer to the above-mentioned range of the present invention. Although the thermal conductivity of the catalyst itself is not particularly limited, it is preferred that the thermal conductivity free of pores as a crystal of a catalyst support component to be filled into a reaction tube be 4 W/(Km) or more. When the catalyst support has such a thermal conductivity, it becomes easy to adjust the thermal conductivity based on a catalyst-filled layer to 0.30 W/(Km) or more.

Although a conventionally known catalyst can be used as the catalyst in the catalyst layer, in a case of a pellet-shaped body having a pore volume of from 0.15 cm³/g to 0.30 cm³/g it is easy to achieve the above-mentioned effective thermal conductivity. When a catalyst having the above-mentioned pore volume is filled, it becomes easier to achieve the above-mentioned thermal conductivity if the voidage of the catalyst layer filled with the catalyst is from 0.6 to 0.8. It is preferred that the catalyst is a pellet-shaped body having a pore volume of from 0.15 cm³/g to 0.30 cm³/g and the voidage of the catalyst layer is from 0.6 to 0.8 because so a reaction efficiency of producing chlorine from hydrogen chloride is superior.

The thermal conductivity can be brought within the range of the present invention even if the pore volume of a catalyst does not satisfy the above-mentioned range, and, for example, when a pore volume is large, the effective thermal conductivity based on a catalyst-filled layer can be increased by filling a catalyst densely or making the catalyst size larger in the case of filling a certain amount of catalyst.

The voidage of the inside of a reaction tube (hereinafter, sometimes referred to as the voidage of a catalyst layer) is e calculated by the following formula when the weight of a catalyst filled in the reaction tube is expressed by W (g), the bulk volume of a catalyst layer is expressed by V (cm³), and the density of a catalyst particle excluding pores is expressed by rₚ (g/cm³). The W/V in the formula is called a filled specific gravity.

e=1−(W/V)/rₚ

The value of the voidage e can be adjusted also by the rate where the catalyst is filled into the reaction tube. As to a case of filling a fixed amount of catalyst into a reaction tube, there is a tendency that the filling density becomes low and the voidage becomes high when the rate of filling a catalyst is high, and there is a tendency that the filling density becomes high and the voidage becomes low when the rate of filling a catalyst is low.

As to the size of the catalyst, although a catalyst of any size that is applied to such a method for producing chlorine can be used, it is preferred to use a pellet-shaped body having, for example, a catalyst diameter of 1.5 mm dia. to 3.0 mm dia. and a length of 3 mm to about 7 mm if it has the above-mentioned pore volume and the voidage is adjusted within the above-mentioned range. In this case, it is easy to control the effective thermal conductivity based on a catalyst-filled layer to 0.30 W/(Km) or more.

The effective thermal conductivity based on a catalyst-filled layer can be adjusted by the proportion of pores or voids existing in the catalyst (i.e., pore volume) as well as the shape of the catalyst (sphere, cylinder, pellet shape, ring shape, cube, and so on), the size of the catalyst, the filling ratio of the catalyst layer, and so on. When the voidage of the reaction tube is expressed by e, the catalyst filling ratio is (100%−100×voidage e).

Specifically, in considering the filling of a catalyst in a reaction tube with a fixed diameter, the effective thermal conductivity based on a catalyst-filled layer can be increased more when the catalyst to be filled has a larger particle diameter, the pore volume in the catalyst is smaller, or the voidage in the reaction tube filled with the catalyst is smaller. In the same shape and the same linear velocity, however, when considering the filling of a catalyst, pressure loss in the reaction tube may become large if the diameter of the reaction tube is small or the catalyst is filled excessively densely.

As to the shape of a catalyst, a catalyst of a spherical shape and a catalyst of a cylindrical pellet shape are advantageous with respect to thermal conductivity from the standpoints of voidage and contact of catalysts, and for catalysts of the same pore volume the above-mentioned effective thermal conductivity can be maintained by filling a catalyst densely if the catalyst size becomes smaller.

It is preferred for the heat-removing capacity of the reactor that the reaction tube be made of a metal, such as nickel or an alloy containing nickel, which is usually used for a method of producing chlorine and have an inner diameter of from 20 mm to 40 mm. When the above-mentioned inner diameter is satisfied, the whole reactor can be made to have a size that has heretofore been used. Although the thickness of the reaction tube is not particularly limited, it is preferably adjusted to about 3 mm or less from the standpoint of heat-removing efficiency when a scale of the whole reactor or a jacket filled with a salt bath is provided.

The reaction tube may be provided with a jacket filled with a heat medium, on the outer circumferential surface as mentioned above. The heat medium to be filled in the jacket is one for removing heat of reaction. In the case of having such heat medium, its temperature is preferably from 250° C. to 400° C. When the heat medium temperature is lower than 250° C., the reaction rate of a hydrochloric acid oxidation reaction may decrease, so that it may be impossible to perform an efficient reaction. When the heat medium temperature is higher than 400° C., it may cause corrosion of an apparatus material, runaway of a reaction, or acceleration of degradation of a catalyst. Moreover, in a case of such a heat medium temperature, the heat-removing effect can be further enhanced in a case where the effective thermal conductivity based on a catalyst-filled layer is 0.30 W/(Km) or more, so that a reaction can be carried out more stably.

Heat media to be used for catalytic gas phase reactions include, for example, salt bath, molten salt, organic heat medium, and molten metal. Among these, the molten salt is preferred from the viewpoint of thermal stability and ease of handling. Examples of the composition of the molten salt include a mixture of 50% by mass of potassium nitrate and 50% by mass of sodium nitrite and a mixture of 53% by mass of potassium nitrate, 40% by mass of sodium nitrite, and 7% by mass of sodium nitrate. The composition of the molten salt is not restricted to the examples provided above and, for example, there can be applied a commercially available heat medium that has a usage range such that a salt bath temperature of from 250° C. to 400° C. can be achieved.

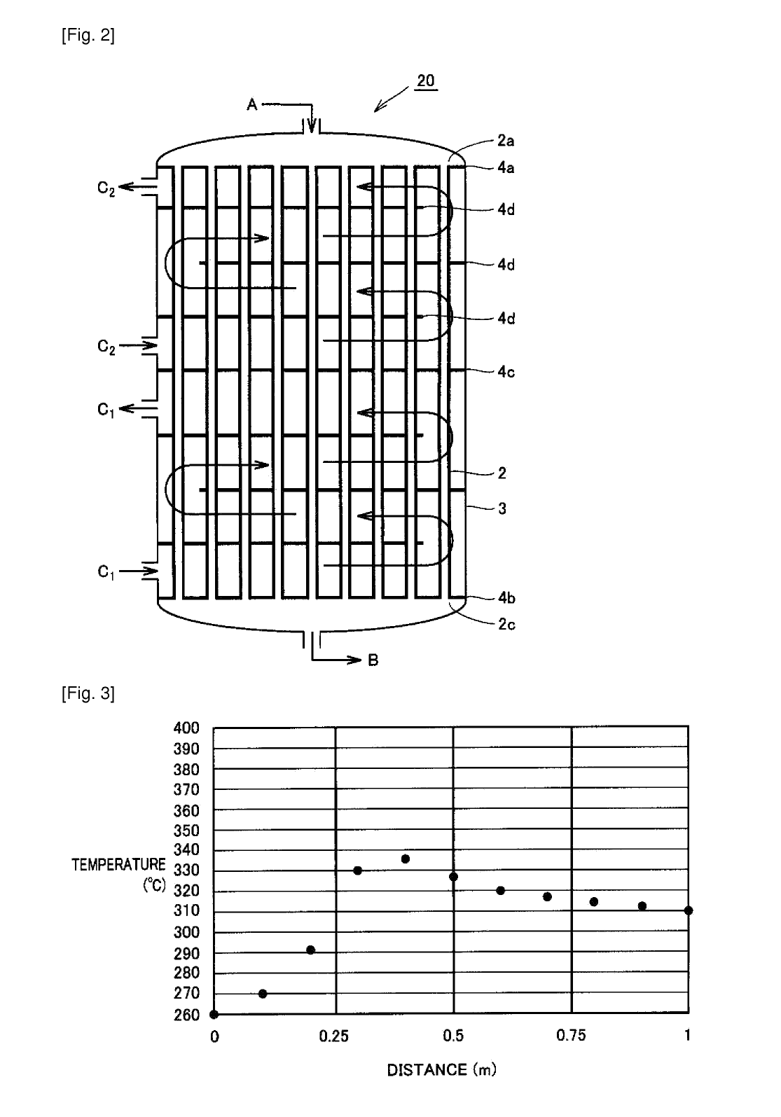

In the method for producing chlorine of the present invention is adopted a fixed bed reaction system. In the fixed bed reaction system is used an apparatus as illustrated in FIG. 2. FIG. 2 is a schematic sectional view of one example of a fixed bed reaction apparatus containing the reaction tube of the present invention. In a reactor 20 are mounted multiple reaction tubes 2 filled with the above-mentioned catalyst (omitted in FIG. 2). In FIG. 2, each reaction tube 2 is equipped with jacket 3 for filling a salt bath. In jacket 3 may be provided a partition plate 4a, a partition plate 4b, a partition plate 4c, and a partition plate 4d. These partition plates are items that support multiple reaction tubes 2 to fix them to jacket 3 or change the directions of flows (C₁ and C₂ in FIG. 2) of a heat medium flowing in jacket 3 to regulate the flows.

Specific examples of the partition plates include a tube plate that fixes reaction tube 2 to jacket 3 in the vicinity of gas inlet 2a of reaction tube 2 arranged on the gas A introduction side of reactor 20 or gas outlet 2c of reaction tube 2 arranged on the gas B discharge side (partition plate 4a and partition plate 4b), a middle tube plate that divides the inside of jacket 3 into multiple sections in the middle of reaction tube 2 (partition plate 4c), and a baffle plate that changes the direction where a heat medium flows in the middle of reaction tube 2 so that the heat medium may flow uniformly in jacket 3 (partition plate 4d).

In the method for producing chlorine of the present invention, it is preferred that the sum total of gas components that do not participate in the reaction to the hydrogen chloride contained in the gas at gas inlet 2a of reaction tube 2 of gas A to be fed to the reactor, i.e., components other than HCl, O₂, Cl₂, and H₂O, be 30% by volume or less. Even if the mixed proportion of a gas component that does not participate in a reaction is small and the reaction rate is relatively high in such a manner, the effective thermal conductivity based on a catalyst-filled layer is 0.30 W/(Km) or more in the present invention, so that the catalyst is not degraded by a hot spot and the production of chlorine can be performed in a high conversion.

With regard to the concentration of hydrogen chloride in raw material hydrogen chloride to be fed to a reactor, one having a concentration of 10% by volume or more, preferably 50% by volume or more, and even more preferably 80% by volume or more of the whole fed gas is used. When the concentration is lower than 10% by volume, separation of generated chlorine and/or recycle in the case of recycling unreacted oxygen may become complicated.

In the operation of a hydrochloric acid oxidation reaction, it is preferred to perform the operation so that a gas superficial velocity in each reaction tube may become from 0.2 m/s to 2 m/s. When the superficial velocity is smaller than 0.2 m/s, there may be a risk of reaction runaway, for example, removal of heat cannot be done appropriately, so that temperature cannot be controlled. When this superficial velocity is larger than 2 m/s, decrease in conversion of hydrogen chloride to chlorine in the reaction tube may be caused. In addition, it causes increase in pressure loss in the reaction tube. It is preferred that the temperature of the heat medium (e.g. salt bath) used for removing heat of reaction generated by a reaction be adjusted to from 250° C. to 400° C. as described above.

In the method for producing chlorine of the present invention, the production of chlorine is performed by using a reaction tube having a specific effective thermal conductivity and, therefore, it is possible to prevent formation of hot spots in excess in a catalyst layer, rapid degradation of a catalyst, corrosion of an apparatus material caused by raw material hydrogen chloride and/or generated chlorine, and a runaway reaction. Consequently, a catalyst cost, an equipment cost, and a safety of operation can be secured by the use of the method for producing chlorine of the present invention.

### EXAMPLES

The present invention will be described in more detail below with reference to Examples, but the invention is not limited thereto.

<Preparation of Catalyst>

(Catalyst A)

Raw Material a
Titanium oxide (STR-60R produced by Sakai Chemical Industry Co., Ltd., 100% rutile form) 50 parts by weight
Alpha-alumina (AES-12 produced by Sumitomo Chemical Co., Ltd.) 100 parts by weight
Titania sol (CSB produced by Sakai Chemical Industry Co., Ltd., titania content 38% by weight) 13.2 parts by weight
Methylcellulose (Metolose 65SH-4000 produced by Shin-Etsu Chemical Co., Ltd.) 2 parts by weight

All the four materials of raw material a were mixed and then were kneaded after adding 33 parts by weight of pure water in order to adjust the pore volume after molding. The resulting mixture was extruded into a cylindrical shape of 3.0 mm dia. in diameter, and it was then crushed into a length of about 4 to 6 mm after drying. The resulting molded body was calcined at 800° C. in air for 3 hours, affording a support composed of a mixture of titanium oxide and alpha-alumina. The support was impregnated with an aqueous solution of ruthenium chloride, dried, and then calcined at 250° C. in air for 2 hours, affording bluish-gray supported ruthenium oxide including ruthenium oxide supported on the support in a support ratio of 2% by weight. The pore volume of this catalyst was 0.209 cm³/g.

(Catalyst B)

All the four materials of raw material a were mixed and then were kneaded after adding 35 parts by weight of pure water in order to adjust the pore volume after molding. The resulting mixture was extruded into a cylindrical shape of 1.5 mm dia. in diameter, and it was then crushed into a length of about 2 to 3 mm after drying. The resulting molded body was calcined at 800° C. in air for 3 hours, affording a support composed of a mixture of titanium oxide and alpha-alumina. The support was impregnated with an aqueous solution of ruthenium chloride, dried, and then calcined at 250° C. in air for 2 hours, affording bluish-gray supported ruthenium oxide including ruthenium oxide supported on the support in a support ratio of 2% by weight. The pore volume of this catalyst was 0.215 cm³/g.

(Catalyst C)

All the four materials of raw material a were mixed and then were kneaded after adding 48 parts by weight of pure water in order to adjust the pore volume after molding. The resulting mixture was extruded into a cylindrical shape of 1.5 mm dia. in diameter, and it was then crushed into a length of about 2 to 3 mm after drying. The resulting molded body was calcined at 800° C. in air for 3 hours, affording a support composed of a mixture of titanium oxide and alpha-alumina. The support was impregnated with an aqueous solution of ruthenium chloride, dried, and then calcined at 250° C. in air for 2 hours, thereby affording bluish-gray supported ruthenium oxide including ruthenium oxide supported on the support in a support ratio of 2% by weight. The pore volume of this catalyst was 0.274 cm³/g.

<Method of Measuring Pore Volume>

A 0.6 to 1.2 g of a catalyst arbitrarily extracted is weighed out and is dried at 120° C. in a drier for 4 hours, and then the sample weight after drying is measured precisely. Subsequently, the sample is mounted in a cell of a pore volume measurement apparatus (AutoPore III9420 manufactured by Micromeritics Instrument Corporation) and the inside of the cell system is adjusted to 50 mmHg or less, and then mercury is filled in a tube. Subsequently, pressure is applied to the cell, and an amount of mercury intrusion at each pressure is measured while a mercury intrusion equilibrium waiting time is adjusted to 10 seconds. The pressure was added from a pressure of 0.007 MPa to a pressure of 412 MPa, and thus an amount of mercury intrusion per gram of the sample was determined as a pore volume (ml/g).

<Voidage of Catalyst Layer>

The voidage of a catalyst layer is e calculated by the following formula when the weight of a catalyst filled in a reaction tube is expressed by W (g), the bulk volume of the catalyst layer is expressed by V (cm³), and the density of a catalyst particle excluding pores is expressed by rₚ (g/cm³). The W/V in the formula is called a filled specific gravity.

e=1−(W/V)/rₚ

<Method of Measuring Effective Thermal Conductivity Based on Catalyst-Filled Layer>

For the measurement of the effective thermal conductivity based on a catalyst-filled layer presented in the present invention was used a thermal conductivity measurement apparatus ARC-TC-100 manufactured by AGNE Gijutsu Center utilizing a nonsteady heat wave method in accordance with JIS R2616 (2001). A cell for measurement having a size of 30 mm in inner diameter and 50 mm in length was used, and the voidage in the cell was adjusted so that it might become the same as that when filling a catalyst into a reaction tube. Since the effective thermal conductivity of a catalyst layer is a physical property value that varies depending upon the temperature, the pressure, and the atmosphere gas, each measurement was carried out at 350° C., 1 atm in an air atmosphere.

The material, shape, and characteristics of catalysts A to C are shown in Table 1.

TABLE 1

| | | Catalyst | | |
|---|---|---|---|---|
| | | A | B | C |
| Raw material | | a | a | a |
| Pure water | (part by weight) | 33 | 35 | 48 |
| Diameter | (mm dia.) | 3.0 | 1.5 | 1.5 |
| Length | (mm) | 4-6 | 2-3 | 2-3 |
| Pore volume | (cm³/g) | 0.209 | 0.215 | 0.274 |

### Example 1

As a reactor was used a fixed bed reactor composed of a Ni reaction tube having an inner diameter of 25 mm and a length of 1 m (a sheath tube for temperature measurement, having an outer diameter of 6 mm) equipped with a jacket filled with a molten salt (potassium nitrate/sodium nitrite=1/1 (weight ratio)) as a base bath. In the reaction tube was filled catalyst A, which was a cylindrical pellet-shaped body having a size of 3 mm dia.×3 to 7 mm, to a layer height of 1 m, so that a reaction tube was produced which had a measured value of an effective thermal conductivity of 0.44 W/(Km) based on a catalyst-filled layer, measured in an air atmosphere (a temperature of 350° C.) and a catalyst-filled layer voidage of 0.68. The catalyst was filled into the reaction tube at a rate of 200 g/min. The filled specific gravity at this time was 1.32 g/cm³. In an upper part of the catalyst layer was filled with alpha-alumina of 3 mm in diameter to a layer height of 0.15 m.

The raw material gas composition was [HCl]=0.54 Nm³/h (“N” in “Nm³/h” represents a standard state; this is also applied hereafter), [O₂]=0.27 Nm³/h, [H₂O]=0.027 kg/h, [CO₂] contained in HCl gas=1% by volume, and [CO] contained in HCl gas=0.01% by volume. The raw material gas feeding linear velocity was 0.58 m/s, the salt bath temperature was 300° C., the gas inlet pressure was 0.342 MPaG, the gas outlet pressure was 0.206 MPaG, and the raw material gas temperature was 260° C. The result of temperature measurement performed in a sheath tube for temperature measurement in a longitudinal direction from the gas inlet toward the gas outlet of the reaction tube is shown in FIG. 3. Delta T was 37° C., so that it was possible to perform operation stably. The conversion was 0.41. Delta T is a temperature difference between the highest temperature and the salt bath temperature in the sheath tube for temperature measurement and is used as an index of temperature controllability. The sheath tube for temperature measurement was arranged so that the diametral center part of the sheath tube for temperature measurement might match the diametral center part of the reaction tube.

### Example 2

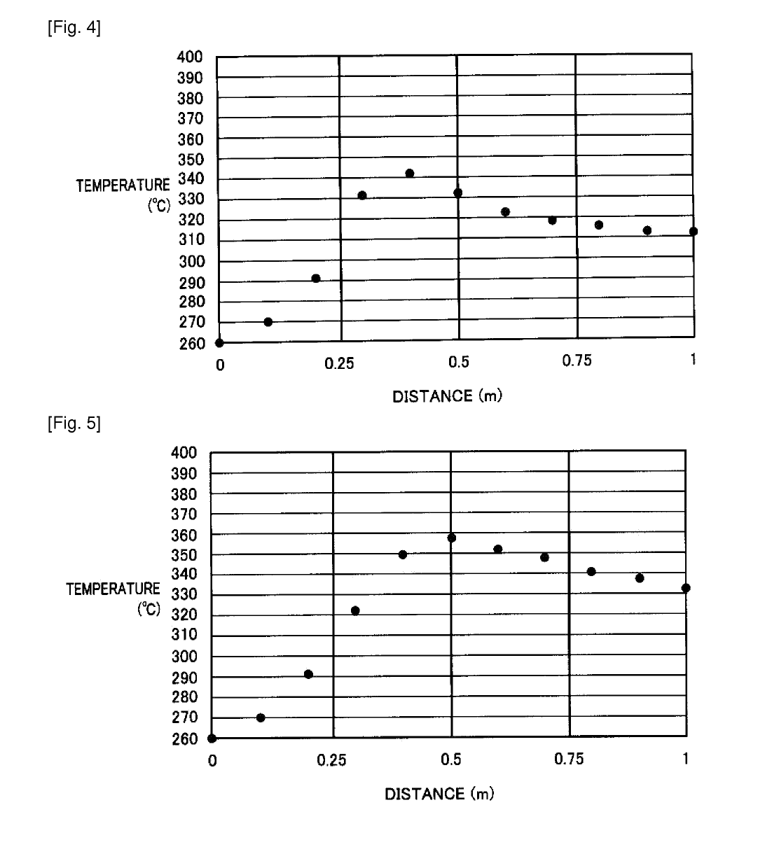

Chlorine was produced by the same method as that of Example 1 except for filling catalyst B that was a cylindrical pellet-shaped body having a size of 1.5 mm dia.×5 mm in place of catalyst A in a reaction tube and using a reaction tube that had a measured value of an effective thermal conductivity of 0.33 W/(Km) based on a catalyst-filled layer, measured in an air atmosphere (a temperature of 350° C.) and a catalyst-filled layer voidage of 0.67. The filled specific gravity in the reaction tube at this time was 1.38 g/cm³. The result of temperature measurement performed in a sheath tube for temperature measurement in a longitudinal direction from the gas inlet toward the gas outlet of the reaction tube is shown in FIG. 4. Delta T was 43° C., so that it was possible to perform operation stably. The conversion was 0.42.

### Example 3

Chlorine was produced by the same method as that of Example 1 except for adjusting the raw material gas composition to [HCl]=1.34 Nm³/h, [O₂]=0.67 Nm³/h, [H₂O]=0.067 kg/h, [CO₂] contained in HCl gas=1% by volume, and [CO] contained in HCl gas=0.01% by volume, the raw material gas feeding linear velocity to 1.45 m/s, and the salt bath temperature to 315° C. The filled specific gravity in the reaction tube at this time was 1.32 g/cm³. The result of temperature measurement performed in a sheath tube for temperature measurement in a longitudinal direction from the gas inlet toward the gas outlet of the reaction tube is shown in FIG. 5. Delta T was 42° C., so that it was possible to perform operation stably. The conversion was 0.33.

### Example 4

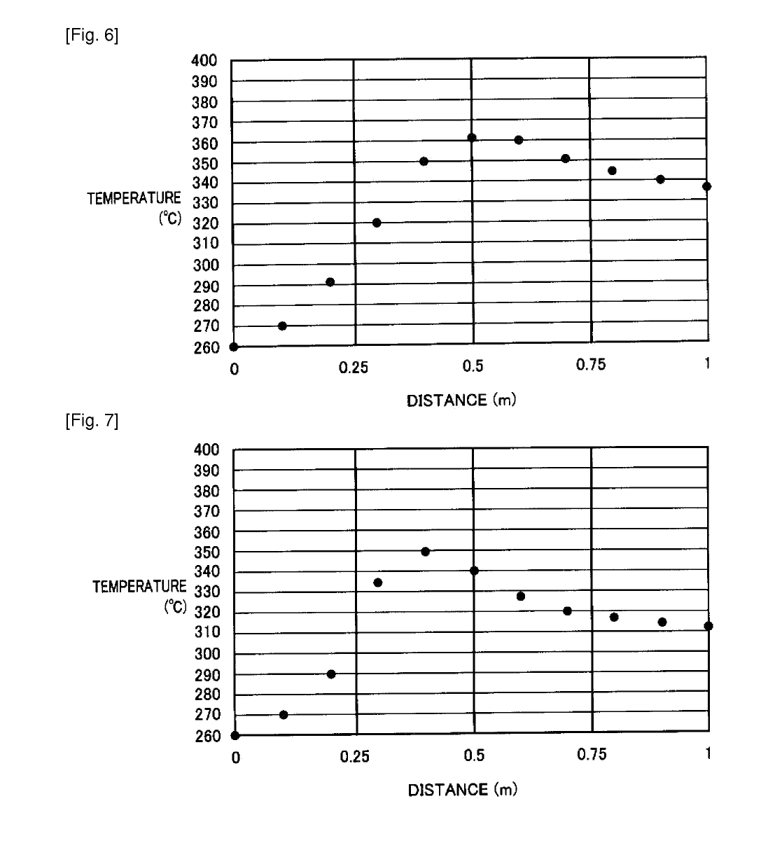

Chlorine was produced by the same method as that of Example 3 except for forming a reaction tube that was the same as that of Example 2 by filling catalyst B in place of catalyst A in a reaction tube. The filled specific gravity in the reaction tube at this time was 1.38 g/cm³. The result of temperature measurement performed in a sheath tube for temperature measurement in a longitudinal direction from the gas inlet toward the gas outlet of the reaction tube is shown in FIG. 6. Delta T was 46° C., so that it was possible to perform operation stably. The conversion was 0.34.

### Comparative Example 1

Chlorine was produced by the same method as that of Example 1 except for filling catalyst C that was a cylindrical pellet-shaped body having a size of 1.5 mm dia.×3 mm in place of catalyst A in a reaction tube and using a reaction tube that had a measured value of an effective thermal conductivity of 0.27 W/(Km) based on a catalyst-filled layer, measured in an air atmosphere (a temperature of 350° C.) and a catalyst-filled layer voidage of 0.721. The filled specific gravity at this time was 1.15 g/cm³. The result of temperature measurement performed in a sheath tube for temperature measurement in a longitudinal direction from the gas inlet toward the gas outlet of the reaction tube is shown in FIG. 7. Delta T became as large as 50° C. The conversion was 0.41. When Delta T became 50° C. or more, temperature control became difficult, so that it was difficult to perform stable operation continuously.

### Comparative Example 2

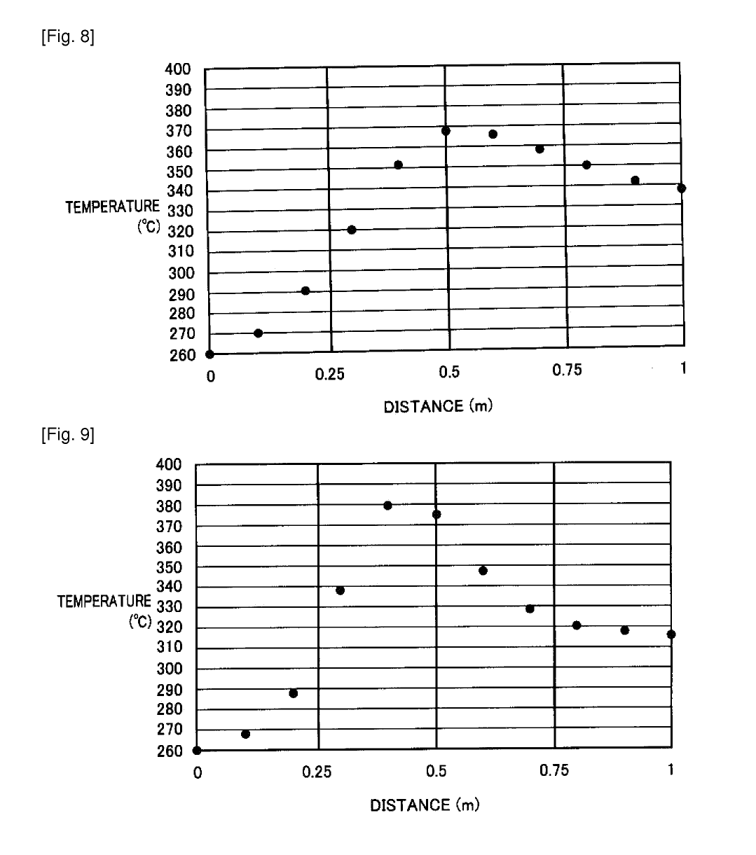

Chlorine was produced by the same method as that of Example 1 except for using the reaction tube of Comparative Example 1 as a reaction tube and adjusting the raw material gas composition to [HCl]=1.34 Nm³/h, [O₂]=0.67 Nm³/h, [H₂O]=0.067 kg/h, [CO₂] contained in HCl gas=1% by volume, and [CO] contained in HCl gas=0.01% by volume, the raw material gas feeding linear velocity to 1.45 m/s, and the salt bath temperature to 315° C. The filled specific gravity of the reaction tube at this time was 1.15 g/cm³. The result of temperature measurement performed in a sheath tube for temperature measurement in a longitudinal direction from the gas inlet toward the gas outlet of the reaction tube is shown in FIG. 8. Delta T became as large as 51° C. The conversion was 0.35. When Delta T became 50° C. or more, temperature control became difficult.

### Example 5

Chlorine was produced in the same manner as in Example 1 except for changing the inner diameter of the used reaction tube to 50 mm. The result of temperature measurement performed in a sheath tube for temperature measurement in a longitudinal direction from the gas inlet toward the gas outlet of the reaction tube is shown in FIG. 9. Delta T became as large as 83° C. The conversion was 0.48. When Delta T became 50° C. or more, temperature control became difficult.

The catalysts, the physical properties of the catalyst layers, and the results in Examples 1 to 5 and Comparative Examples 1 and 2 are shown in Table 2.

TABLE 2

| | | Catalyst-filled layer | | | | |
|---|---|---|---|---|---|---|
| | | | Packed | | | |
| | | Thermal | specific | | Delta | Con- |
| | | conductivity | gravity | Voidage | T | version |
| | Catalyst | (W/(K · m)) | (g/cm³) | e | (° C.) | ratio |
| Example 1 | A | 0.44 | 1.32 | 0.68 | 37 | 0.41 |
| Example 2 | B | 0.33 | 1.38 | 0.67 | 42 | 0.42 |
| Example 3 | A | 0.44 | 1.32 | 0.68 | 42 | 0.33 |
| Example 4 | B | 0.33 | 1.38 | 0.67 | 46 | 0.34 |
| Comparative | C | 0.27 | 1.15 | 0.721 | 50 | 0.41 |
| Example 1 | | | | | | |
| Comparative | C | 0.27 | 1.15 | 0.721 | 51 | 0.35 |
| Example 2 | | | | | | |
| Example 5 | A | 0.44 | 1.32 | 0.68 | 83 | 0.48 |

As is clear from the results of Table 2, it is possible to produce chlorine efficiently under stable operation by a method for producing chlorine using a catalyst layer having an effective thermal conductivity of 0.30 W/(Km) or more based on a catalyst-filled layer.

### REFERENCE SIGNS LIST

1 Catalyst, 2 reaction tube, 2a gas inlet, 2b inside of reaction tube, 2c gas outlet, 3 salt bath, 4a, 4b, 4c, and 4d partition plates, 10 catalyst-filled layer, 11 catalyst layer, 20 reactor.

1. A method for producing chlorine, the method comprising a reaction of oxidizing hydrogen chloride in a gas containing the hydrogen chloride using a gas containing oxygen by a fixed bed reactor having a reaction region composed of a catalyst layer, wherein
said catalyst layer has an effective thermal conductivity of 0.30 W/(Km) or more, based on a catalyst-filled layer, measured at 350° C. in an air atmosphere.

2. The method for producing chlorine according to claim 1, wherein said fixed bed reactor comprises a catalyst and a reaction tube where the catalyst is filled, said reaction tube is made of a metal and has an inner diameter of from 20 mm to 40 mm.

3. The method for producing chlorine according to claim 2, wherein a gas that does not participate in a reaction to the hydrogen chloride contained in the gas at the gas inlet of said reaction tube is 30% by volume or less.

4. The method for producing chlorine according to claim 2, wherein said reaction tube has on its outer circumferential surface a jacket filled with a salt bath for removing heat of reaction and the temperature of said salt bath is from 250° C. to 400° C.

5. The method for producing chlorine according to claim 2, wherein said catalyst is a pellet-shaped body having a pore volume of from 0.15 cm³/g to 0.30 cm³/g, and the voidage e of said catalyst layer filled with the catalyst is from 0.6 to 0.8.

6. A reaction tube to be used in a method for producing chlorine comprising a reaction of oxidizing hydrogen chloride in a gas containing the hydrogen chloride using a gas containing oxygen by a fixed bed reaction system having a reaction region composed of a catalyst layer, wherein
a catalyst is filled in said reaction tube to form said catalyst layer,
said catalyst is a pellet-shaped body having a pore volume of from 0.15 cm³/g to 0.30 cm³/g, the voidage e of said catalyst layer filled with the catalyst is from 0.6 to 0.8, and
said catalyst layer has an effective thermal conductivity of 0.30 W/(Km) or more, based on a catalyst-filled layer, measured at 350° C. in an air atmosphere.
